(19) United States
(12) Patent Application Publication
(10) Pub. No.: US 2016/0299353 A1
(43) Pub. Date: Oct. 13, 2016

(54) EYEGLASSES ASSEMBLY STRUCTURE

(71) Applicant: PROHERO GROUP CO., LTD., TAINAN CITY (TW)

(72) Inventor: PEN-WEI CHEN, TAINAN CITY (TW)

(21) Appl. No.: 14/683,448

(22) Filed: Apr. 10, 2015

(51) Int. Cl. G02C 5/22; G02C 5/14

(52) U.S. Cl. CPC G02C 5/2209; G02C 5/146; G02C 2200/08

(57) ABSTRACT

An eyeglasses assembly structure is revealed. It comprises a lens having a groove and an orientation trough on both peripheral edges thereof and a pair of temples. Each of the temples has a concave slot for engaging with the lens, and the concave slot has a pivot for pivotally connecting to the groove and a positioning rod for engaging with the orientation trough.

### BACKGROUND OF THE INVENTION

1. Field of the Invention

The present invention relates to an eyeglasses assembly structure comprising a lens and a pair of temples which can be attached to or detached from the lens rapidly without using tools.

2. Description of Related Art

Various eyeglasses, e.g. optical glasses, sunglasses, sport glasses and safety glasses, have different design for frame structure according to specific purpose and function. For instance, full-frame eyeglasses having a frame for enclosing a lens firmly are usually utilized as expensive optical glasses, whereas half-frame eyeglasses having a relative light weight are usually utilized as sunglasses, sport glasses, or safety glasses to increase users' expedience in outdoor activities, sports or construction work. Whether the eyeglasses are full-frame or half-frame form, they share the same characteristic of assembling both sides of the frame engaged with a lens to temples by fastening elements.

Although the abovementioned eyeglasses achieve various expected efficacy, e.g. vision correction, eye protection and the like, they have some restrictions on the overall structural design. For instance, the temples must assemble to the lens by the frame, so the temples cannot be attached to or detached from the lens arbitrarily.

### SUMMARY OF THE INVENTION

In view of the above-mentioned problems, the object of the present invention is to provide an eyeglasses assembly structure which comprises a pair of temples for engaging with a lens directly, allowing the pair of temples to bond to or detached from the lens easily without using tools.

Disclosed herein is an eyeglasses assembly structure, comprising a lens having a groove and an orientation trough on both peripheral edges thereof; and a pair of temples, each having a concave slot for engaging with the lens, wherein the concave slot has a pivot for pivotally connecting to the groove and a positioning rod for engaging with the orientation trough.

According to an embodiment of the present invention, the pivot and the positioning rod of the temple are shaped as cylinders, and the groove and the orientation trough of the lens are formed as circular recesses for correspondingly receiving the pivot and the positioning rod.

### BRIEF DESCRIPTION OF THE DRAWINGS

FIG. 1 is a stereogram showing an eyeglasses assembly structure according to the present invention;

FIG. 2 is a cross-sectional diagram showing the eyeglasses assembly structure in disassembly according to the present invention;

FIG. 3 is a cross-sectional diagram showing the eyeglasses assembly structure in assembly according to the present invention;

FIG. 4 is a cross-sectional diagram showing the eyeglasses assembly structure in use according to the present invention.

### DETAILED DESCRIPTION OF THE PREFERRED EMBODIMENT

Hereinafter, an exemplary embodiment of the present invention will be described in detail with reference to the accompanying drawings.

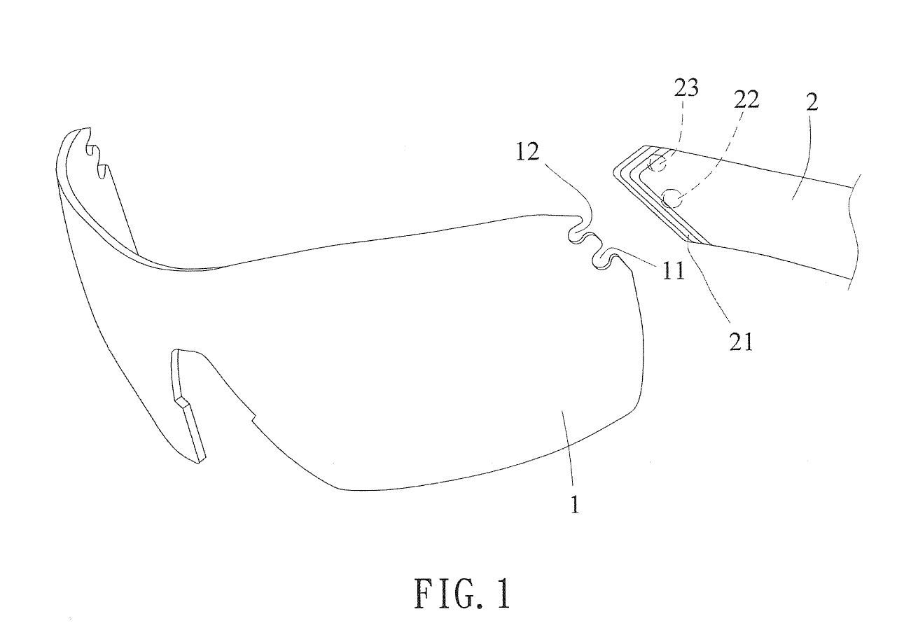

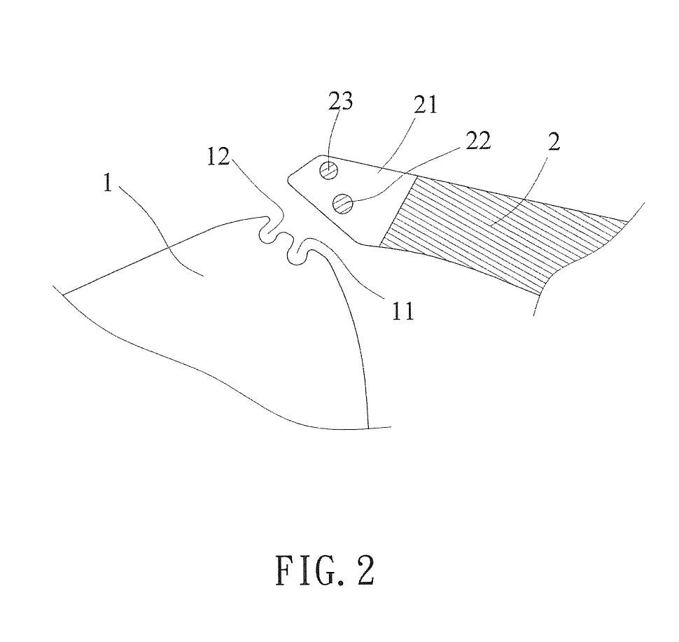

As shown in FIG. 1 and FIG. 2, a stereogram showing an eyeglasses assembly structure and a cross-sectional diagram showing the eyeglasses assembly structure in disassembly according to the present invention are disclosed. An eyeglasses assembly structure comprises a lens (1) having a groove (11) and an orientation trough (12) on both peripheral edges thereof; and a pair of temples (2), each having a concave slot (21) for engaging with the lens (1), wherein the concave slot (21) has a pivot (22) for pivotally connecting to the groove (11) and a positioning rod (23) for engaging with the orientation trough (12). As the foregoing description, the pivot (22) and the positioning rod (23) of the temple (2) are shaped as cylinders, and the groove (11) and the orientation trough (12) of the lens (1) are formed as circular recesses for correspondingly receiving the pivot (22) and the positioning rod (23).

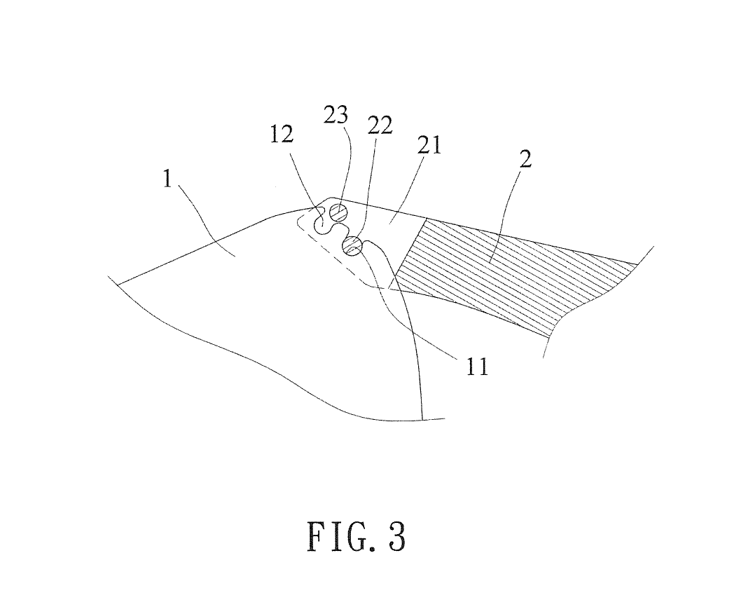

As shown in FIG. 3, a cross-sectional diagram showing the eyeglasses assembly structure in assembly according to the present invention is revealed. Both peripheral edges of the lens (1) are engaged with the concave slots (21) of the temples (2). The pivot (22) in the concave slots (21) is pivotally connected to the groove (11) of the lens (1) first, and then the temple (2) is pushed toward the orientation trough (12) of the lens (1), allowing the positioning rod (23) in the concave slots (21) of the temples (2) to engage with the orientation trough (12) of the lens (1) firmly.

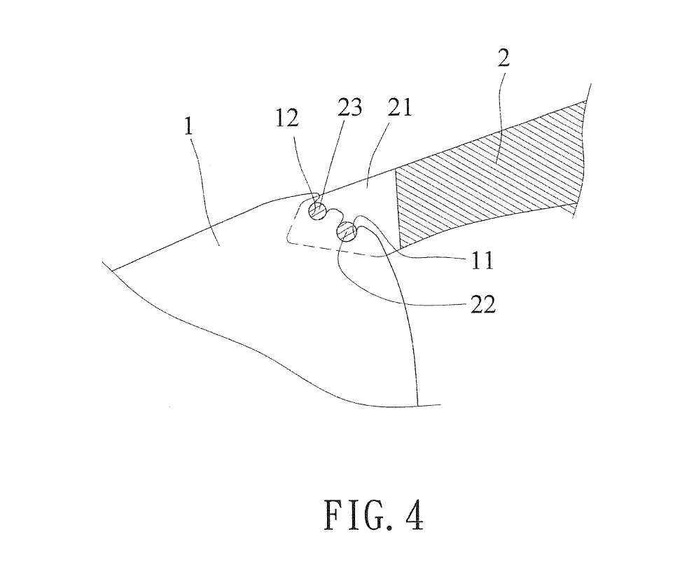

As shown in FIG. 4, a cross-sectional diagram showing the eyeglasses assembly structure in use according to the present invention is revealed. When users want to take off the lens (1) from the temples (2), they can pull the temples (2) toward the opposite direction of the orientation trough (12) of the lens (1), allowing the positioning rod (23) in the concave slot (21) of the temples (2) to detach from the orientation trough (12) of the lens (1). Then users can detach the temple (2) from the lens (1) easily by pulling the temple (2) outwardly to detach the pivot (22) in the concave slot (21) from the groove (11) of the lens (1).

According to the above description, in comparison with the traditional technique, an eyeglasses assembly structure according to the present invention has the advantages as following:

1. The present invention comprises a lens directly bonding to a pair of temples, so the temples can be attached to or detached from the lens rapidly and easily without using tools.

What is claimed is:

1. An eyeglasses assembly structure, comprising
a lens having a groove and an orientation trough on both peripheral edges thereof; and
a pair of temples, each having a concave slot for engaging with the lens, wherein the concave slot has a pivot for pivotally connecting to the groove and a positioning rod for engaging with the orientation trough.

2. The eyeglasses assembly structure as claimed in claim 1, wherein the pivot and the positioning rod of the temple are shaped as cylinders, and the groove and the orientation trough of the lens are formed as circular recesses for correspondingly receiving the pivot and the positioning rod.
